(19) United States
(12) Patent Application Publication
(10) Pub. No.: US 2012/0268611 A1
(43) Pub. Date: Oct. 25, 2012

(54) ELECTRONIC APPARATUS, CONTROL METHOD THEREOF, AND PROGRAM THEREFOR

(75) Inventors: Tadaaki KIMIJIMA, Tokyo (JP); Yumi TAKAHASHI, Tokyo (JP); Hiroshi KIMOTO, Tokyo (JP); Hideaki KAMEI, Chiba (JP); Wonjoon CHO, Tokyo (JP); Shigeharu KONDO, Kanagawa (JP)

(73) Assignee: SONY CORPORATION, Tokyo (JP)

(21) Appl. No.: 13/444,111

(22) Filed: Apr. 11, 2012

(30) Foreign Application Priority Data
Apr. 21, 2011 (JP) 2011-095017

(51) Int. Cl. H04N 5/225

(52) U.S. Cl. 348/207.1; 348/E05.024

(57) ABSTRACT

A portable terminal forms the same group with one or more portable terminals. The portable terminal receives photographed images that are photographed by the other portable terminals belonging to the same group and displays the received photographed images. The disclosure of this technology is applicable to, for example, an electronic apparatus such as a portable telephone.

### BACKGROUND

The present disclosure relates to an electronic apparatus, a control method thereof, and a program therefor, and, more particularly, to an electronic apparatus that allows photographed images taken by a plurality of users to be quickly viewed among the users.

In order to share a photographed image taken by a digital camera among a plurality of users, for example, data of the photographed image stored in a storage section in the digital camera is transferred to a personal computer (hereinafter, referred to as “PC”), and then transmitted to other users by electronic mail or the like. Alternatively, the data of the photographed image was uploaded from the PC to a website of a photograph sharing service, and other users are notified of an address (URL) of the uploaded destination.

However, since the data of the photographed image is transferred to the PC, an arrangement involves time and effort such as connecting the digital camera to the PC by USB connection, or moving a memory card storing therein the data of the photographed image to the PC and producing a duplicate thereof.

In view of this, for example, an Internet website of Eye-Fi, Inc., i.e., URL: “http://www.eyefi.co.jp/” which was searched on Apr. 5, 2011, and an Internet website, i.e., URL: “http://plusditmedia.co.jp/mobile/articles/1101/05/news072.html” which was searched on Apr. 5, 2011, offer a method in which the data of the photographed image that is taken by a digital camera and stored in a memory card is transferred to a PC or a website of a photograph sharing service by wireless communication using a memory card provided with a wireless LAN function.

### SUMMARY

However, the aforementioned sharing methods all relate to a method in which the data of the photographed image is shared among users after a certain time elapses since the image was photographed. Accordingly, for example, in an event site such as a wedding ceremony, it is difficult for users to quickly view each other's photographed images on site.

In view of the circumstances as described above, it is desirable to allow images individually photographed by a plurality of users to be quickly viewed among the users.

According to one aspect of the present technology, an electronic apparatus may include a group formation section that constitutes a same group with one or more communication terminals on a local area network, a communication section that receives data of a photographed image that is photographed by the communication terminal belonging to the same group, and a display section that displays the photographed image thus received.

According to another aspect of the present technology, there is provided a control method for an electronic apparatus including a group formation section, a communication section, and a display section. The control method may include forming by the group formation section a same group with one or more communication terminals on a local area network, receiving by the communication section data of a photographed image that is photographed by the communication terminal belonging to the same group, and displaying by the display section the photographed image thus received.

According to another aspect of the present technology, a program causing computer to execute may include forming a same group with one or more communication terminals on a local area network, receiving data of a photographed image that is photographed by the communication terminal belonging to the same group, and displaying the photographed image thus received on a display section.

According to another aspect of the present technology, a same group is formed with one or more communication terminals on a local area network, photographed images that are photographed by the communication terminals belonging to the same group are received, and the received photographed images are displayed on a display section.

The program can be provided by transmission through a transmission medium, or in a form of a storage medium by storing the program therein.

The electronic apparatus may be an independent apparatus or an internal block that forms a device.

According to one aspect of the present technology, the photographed images that are photographed by a plurality of users can be quickly viewed among the users.

### BRIEF DESCRIPTION OF THE DRAWINGS

FIG. 1 is a diagram illustrating a configuration example of a communication system according to an embodiment to which the present technology is applied;

FIG. 2 is a diagram for briefly explaining a function of a photograph sharing application;

FIG. 3 is a block diagram illustrating a configuration example of a portable terminal;

FIG. 4 is a block diagram illustrating a functional configuration example of the photograph sharing application;

FIG. 5 is a diagram for explaining how to start the photograph sharing application;

FIG. 6 is a flowchart for explaining a main process of the photograph sharing application;

FIG. 7 is a diagram illustrating an example of a screen displayed on the portable terminal when the photograph sharing application is started;

FIG. 8 is a diagram illustrating an example of a user registration screen;

FIG. 9 is a diagram for briefly explaining a connection process;

FIG. 10 is a diagram illustrating a screen example of a View mode;

FIG. 11 is a diagram illustrating a screen example of the View mode;

FIG. 12 is a diagram illustrating a screen example of the View mode;

FIG. 13 is a diagram illustrating a screen example of the View mode;

FIG. 14 is a diagram illustrating a screen example of a Camera mode;

FIG. 15 is a diagram for explaining a connection release process;

FIG. 16 is a flowchart for explaining details of the connection process;

FIG. 17 is a flowchart for explaining details of an image taking process;

FIG. 18 is a flowchart for explaining details of a photographed image interruption process;

FIG. 19 is a diagram illustrating a screen example of a toast pop-up display

FIG. 20 is a diagram illustrating a screen example of the View mode;

FIG. 21 is a diagram for explaining a user list consistency maintenance process;

FIG. 22 is a flowchart for explaining a user list consistency maintenance process;

FIGS. 23A and 23B are diagrams for explaining an example of another display method of a photographed image; and

FIGS. 24A to 24D are diagrams for explaining an example of another display method of a photographed image.

### DETAILED DESCRIPTION OF THE EMBODIMENTS

### [Configuration Example of Communication System]

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

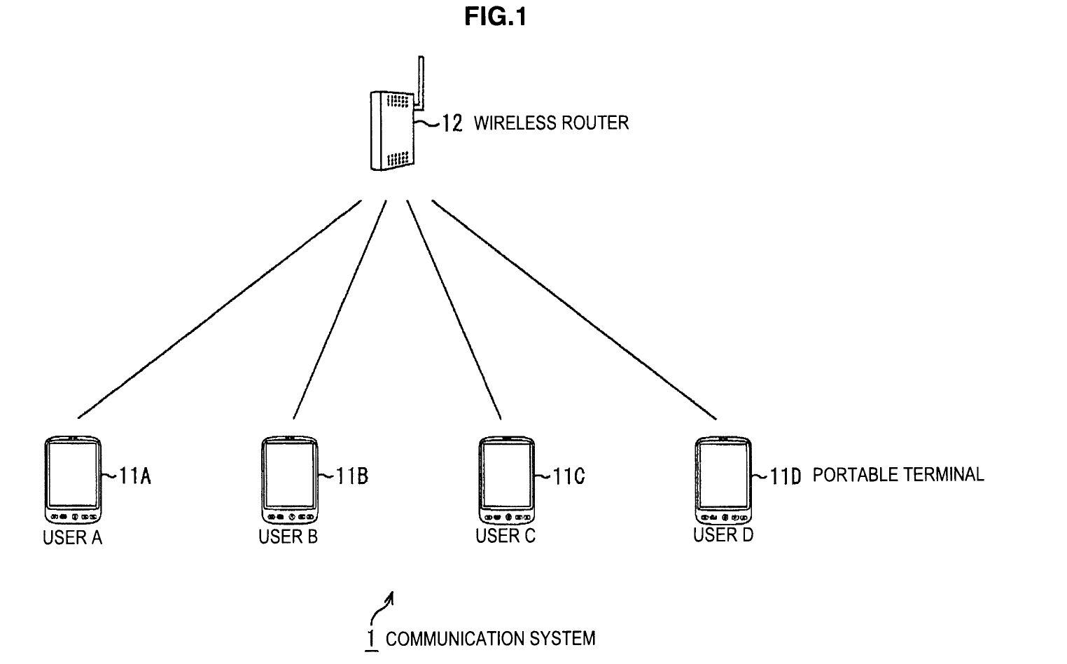

FIG. 1 illustrates a configuration example of a communication system according to an embodiment to which the present technology is applied.

A communication system 1 illustrated in FIG. 1 is configured of four portable terminals 11A to 11D and a wireless router 12. To state it differently, the portable terminals 11A to 11D and the wireless router 12 form a network (local area network).

The four portable terminals 11A to 11D are owned by different users A to D, respectively. In this embodiment, although the portable terminals 11 individually owned by four users are connected to one network, the number of the portable terminals 11 connected to the network is not limited to this example.

The portable terminal 11 is a sophisticated portable telephone such as a so-called smart phone, having the functions of both the portable telephone and the personal digital assistant. The portable terminal 11 has, in addition to a verbal communication function as a portable telephone, a wireless LAN communication function for performing a wireless communication with another portable terminal 11 through the wireless router 12 by a WiFi (Wireless Fidelity) method (IEEE (Institute of Electrical and Electronic Engineers) 802.11x).

In addition, the portable terminal 11 also has a photographing function for taking a picture of a subject.

Further, the portable terminal 11 is installed with a “photograph sharing application” which is software executed in the portable terminal 11.

### [Description of Photograph Sharing Application]

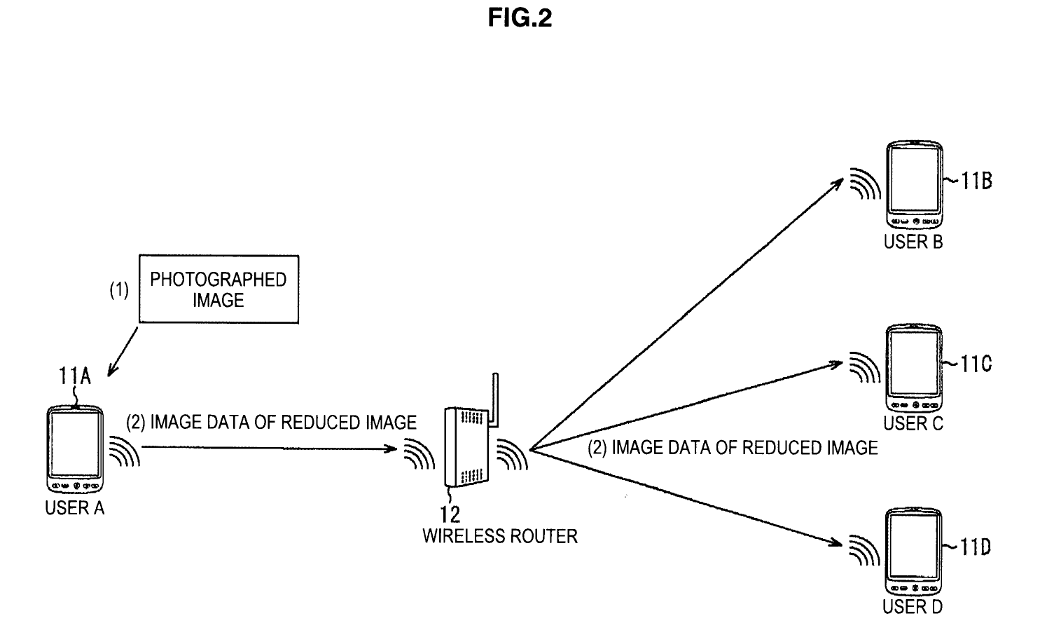

Referring to FIG. 2, a function of the “photograph sharing application” executed in the portable terminal 11 will be briefly described.

As illustrated in FIG. 2, for example, the user A uses his or her own portable terminal 11A and takes a photograph of a predetermined subject. The photographed image thus captured by photographing is stored in the portable terminal 11A. Further, image data of a reduced image resulted from reducing the photographed image is transmitted to the portable terminals 11B, 11C, and 11D on the same network through the wireless router 12. The reduced image is an image resulted from reducing the photographed image at a predetermined ratio such as 1/2. With this arrangement, the other users B, C, and D can quickly view, on their individual terminals 11, the photographed image taken by the user A.

In this way, when the “photograph sharing application” is executed, the photographed image can be shared among the plurality of portable terminals 11. The “photograph sharing application” can be used, for example, in an event such as a wedding ceremony or a birthday party where many people gather together. The users A to D are participants of the event, and the wireless router 12 is installed in the event site. In this case, in the event site, the users A to D can enjoy by quickly viewing the photographed images of each other taken by their portable terminals 11A to 11D.

### [Configuration Block Diagram of Portable Terminal 11]

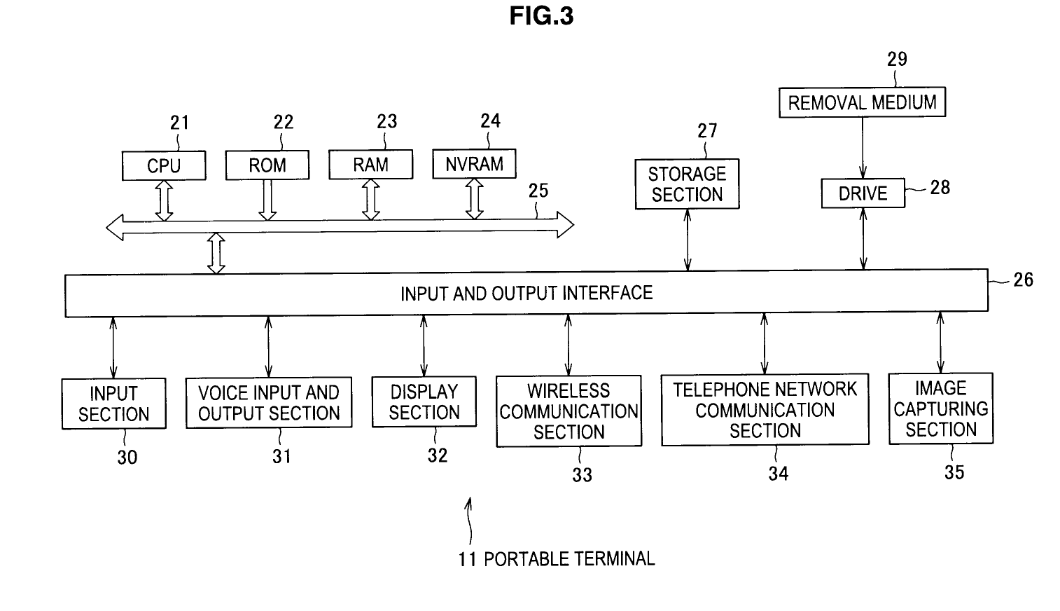

FIG. 3 is a block diagram illustrating a configuration example of the portable terminal 11.

Referring to FIG. 3, a CPU (Central Processing Unit) 21 is a processing unit for performing various types of processing. The CPU 21 also executes a software program such as the photograph sharing application. The CPU 21, a ROM (Read Only Memory) 22, a RAM (Random Access Memory) 23, and an NVRAM (Non Volatile RAM) 24 are connected to each other through a bus 25. Also, an input and output interface 26 is connected to the bus 25, and a storage section 27 and a drive 28 are connected to the input and output interface 26.

The ROM 22 stores therein a software program or data beforehand. The software program or the data stored in the ROM 22 or the storage section 27 is loaded to the RAM 23 and the NVRAM 24. The RAM 23 and the NVRAM 24 also arbitrarily store therein data or the like which is necessary for the CPU 21 to perform various types of processing. The storage section 27 is configured of a flash memory or a hard disk and stores therein at least the photograph sharing application.

The drive 28 is fitted as necessary, reads out data from a removable medium 29 such as a semiconductor memory, and feeds the data to the CPU 21 through the input and output interface 26 or the like or writes data fed from the CPU 21 into the removable medium 29. The data to be read and written includes data of a program (application) to be installed in addition to the data of the photographed image.

An input section 30, a voice input and output section 21, a display section 32, a wireless communication section 33, a telephone network communication section 34, and an image capturing section 35 are connected to the input and output interface 26.

The input section 30 is configured of a keyboard, operation buttons, a touch panel, or the like, receives an input caused by user's operation, and feeds the input to the CPU 21 or the like. The voice input and output section 31 is configured of a speaker, a microphone, or the like, inputs and outputs voice for a verbal communication. The display section 32 is formed of an LCD (Liquid Crystal Display), an organic EL (Electro Luminescence) display, or the like and displays thereon a predetermined image (screen).

The wireless communication section 33 performs a wireless communication by a WiFi method. The telephone network communication section 34 performs a verbal communication or a packet communication with another device through a mobile phone communication network. The image capturing section 35 is configured of an image pickup device such as a CCD (Charge Coupled Device) or a CMOS (Complementary Metal Oxide Semiconductor) sensor. The image capturing section 35 captures an image of a subject and feeds image data of the subject thus captured to the CPU 21 or the like through the input and output interface 26.

The portable terminal 11 is configured as described above. The portable terminal 11 may be arranged to include other configuration such as a non-contact communication section for performing a non-contact communication while keeping a short distance of about several centimeters utilizing electromagnetic induction, a wireless communication portion such as a Bluetooth (registered trademark) method, or an infrared communication section for performing a communication by infrared rays.

### [Functional Configuration Block Diagram of Photograph Sharing Application]

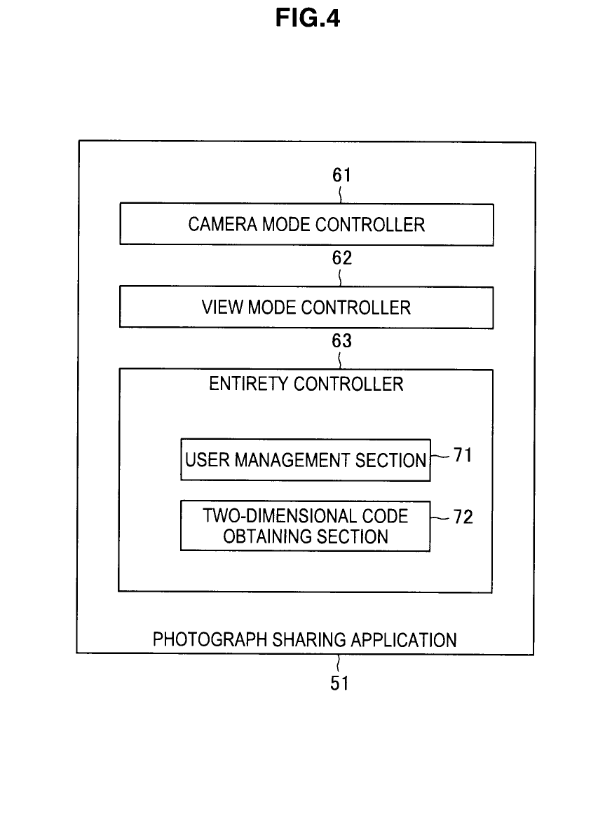

FIG. 4 is a block diagram illustrating a functional configuration example of the photograph sharing application which is implemented when the CPU 21 executes the photograph sharing application.

A photograph sharing application 51 includes two operation modes, namely, a Camera mode (photographing mode) and a View mode (viewing mode). The Camera mode is an operation mode in which the user himself or herself takes an image of a subject, the photographed image (photograph) obtained by photographing is stored in the storage section 27 and transmitted to other users by wireless communication. The View mode is an operation mode in which the photographed image captured by photographing and stored in the storage section 27 is viewed, or photographed image captured by the other user and quickly transmitted by wireless communication is viewed.

The photograph sharing application 51 includes a Camera mode controller 61 for controlling the Camera mode, a View mode controller 62 for controlling the View mode, and an entirety controller 63.

The entirety controller 63 controls the photograph sharing application 51 in its entirety such as switching control between the Camera mode and the View mode. The entirety controller 63 also includes a user management section 71 and a two-dimensional code obtaining section 72. The user management section 71 manages the users in a state resulted from connection and disconnection of the other portable terminals 11 to and from the network. The two-dimensional code obtaining section 72 obtains information read out from the two-dimensional code (QR (Quick Response) code (registered trademark)) which is photographed by the image capturing section 35.

### [Starting Photograph Sharing Application 51]

A starting method of the photograph sharing application 51 will be described.

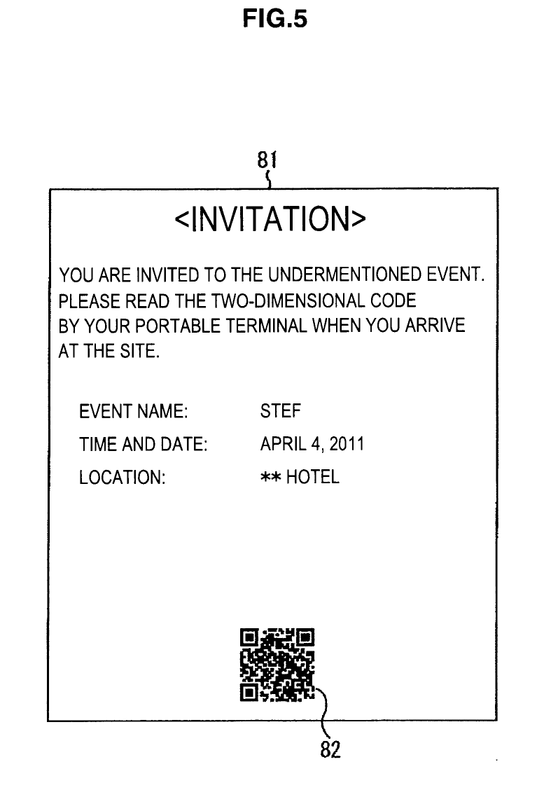

For example, an invitation 81 illustrated in FIG. 5 is delivered beforehand to users who are participants of an event such as a wedding ceremony.

As illustrated in FIG. 5, a description about a title of the event, time and date, location, and the like, and a two-dimensional code 82 are printed on the invitation 81.

The two-dimensional code 82 at least includes, in a superimposed manner, a group ID (group identification information) which is assigned for each event and common to all participants of the event, and a command for executing the start of the photograph sharing application 51.

The invitation 81 also carries thereon a description of “Please read the two-dimensional code by your portable terminal when you arrive at the site.”, and therefore the user photographs the two-dimensional code 82 printed on the invitation 81 by the image capturing section 35 of the portable terminal 11 at the event site.

The CPU 21 of the portable terminal 11 starts the photograph sharing application 51 based on the two-dimensional code 82 photographed by the image capturing section 35, and supplies the group ID read from the two-dimensional code 82 to the photograph sharing application 51.

If the photograph sharing application 51 is not installed in the portable terminal 11 of the user, the two-dimensional code 82 may be configured to superimpose therewith a command for displaying a screen that allows the photograph sharing application 51 to be installed. Specifically, the portable terminal 11 may display a screen by which the user is guided to an application providing website (application market) from which the photograph sharing application 51 can be downloaded when the two-dimensional code 82 is read by the portable terminal 11.

Further, the two-dimensional code 82 may include in advance, in a superimposing manner, a nickname or the like of the user who participates in the event as user identification information (user name) for identifying the user in addition to the group ID. With this arrangement, the user can automatically join in the group with the given user name simultaneously with the start of the photograph sharing application 51, which releases the user from inputting the user name and allows the user to easily participate in the event. In addition to this, an event name or the like may be superimposed.

FIG. 5 illustrates an example of the two-dimensional code 82 as a method for automatically starting the photograph sharing application 51 or a method for providing the group ID to the user. However, for example, a URL including automatic starting of the photograph sharing application 51 or information of the group ID may be used instead. In this case, when the URL is accessed, the group ID is obtained, and the photograph sharing application 51 is started.

In addition, other than delivering the invitation 81 to the user in a form of paper, it can also be arranged to deliver it by electronic mail or allow the user to view a document composed of HTML on a predetermined website.

### [Main Process Flow of Photograph Sharing Application 51]

A description will be given of a main process of the photograph sharing application 51 which is executed when the two-dimensional code 82 of the invitation 81 is read.

First, in step S11, the entirety controller 63 acquires information read out from the two-dimensional code 82. For example, the entirety controller 63 acquires an event name, a group ID, and a user name as the information read out from the two-dimensional code 82.

In step S12, the entirety controller 63 determines whether the user has been registered or not. If it is determined that the user has not been registered in step S12, the entirety controller 63 performs, in step S13, a user registration process by which the user is registered.

In contrast, if it is determined that the user has been registered in step S12, or when step S13 completes, the process advances to step S14. If the information read out from the two-dimensional code 82 includes the user name, it is determined, in step S12, that the user has been already registered.

### [Example of Start Screen]

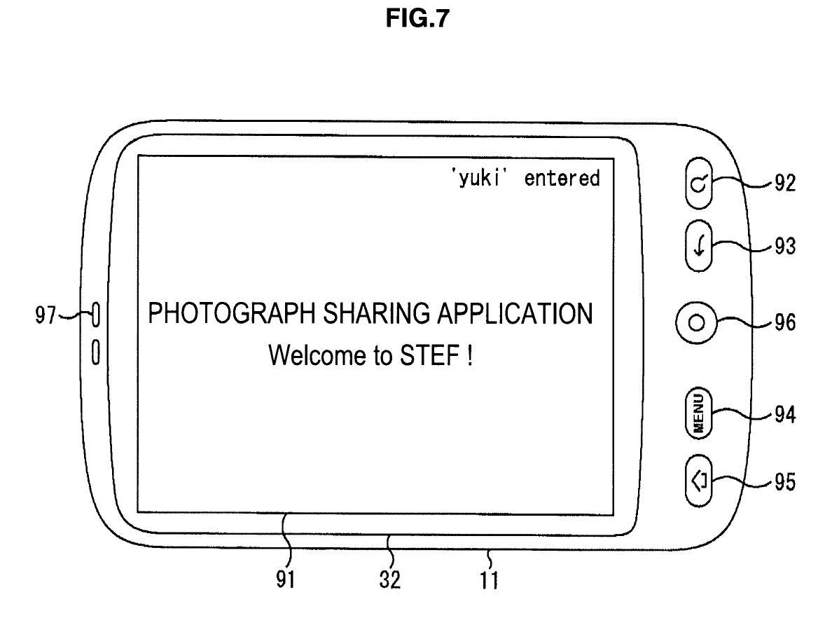

FIG. 7 illustrates an example of a screen displayed on the portable terminal 11 when the photograph sharing application 51 is started and the user has been already registered.

The display section 32 of the portable terminal 11 displays a start screen 91 of the photograph sharing application 51.

The start screen 91 displays thereon “Photograph Sharing Application” which is a title of the photograph sharing application 51, and “Welcome to STEF!” including an event name of “STEF” which is one piece of the information read out from the two-dimensional code 82. The start screen 91 also displays, in a right upper position thereon, “‘yuki’ entered” which indicates that a user having a user name of ‘yuki’ read out from the two-dimensional code 82 has participated in the group of the event name ‘STEF’. The message of “‘yuki’ entered” is also displayed in the right upper position of the screen of the portable terminals 11 of the other users who are already participated in the event having the event name of ‘STEF’.

A surface on which the display section 32 of the portable terminal 11 is arranged is provided, on the right side of the display section 32, with an enlargement button 92, a return button 93, a menu button 94, and a home button 95 which are operation buttons belonging to the input section 30. In addition, an image pickup device 96 belonging to the image capturing section 35 is also provided. Here, the image capturing section 35 includes two image pickup devices of which one is for photographing oneself which is called a self shot and the other is for photographing other person, and the image pickup device 96 is for photographing oneself. An image pickup device for photographing the other person in provided on a surface opposite to the surface on which the display section 32 is provided. In addition, a speaker 97 belonging to the voice input and output section 31 is proved on the left side of the display section 32.

### [Example of User Registration Screen]

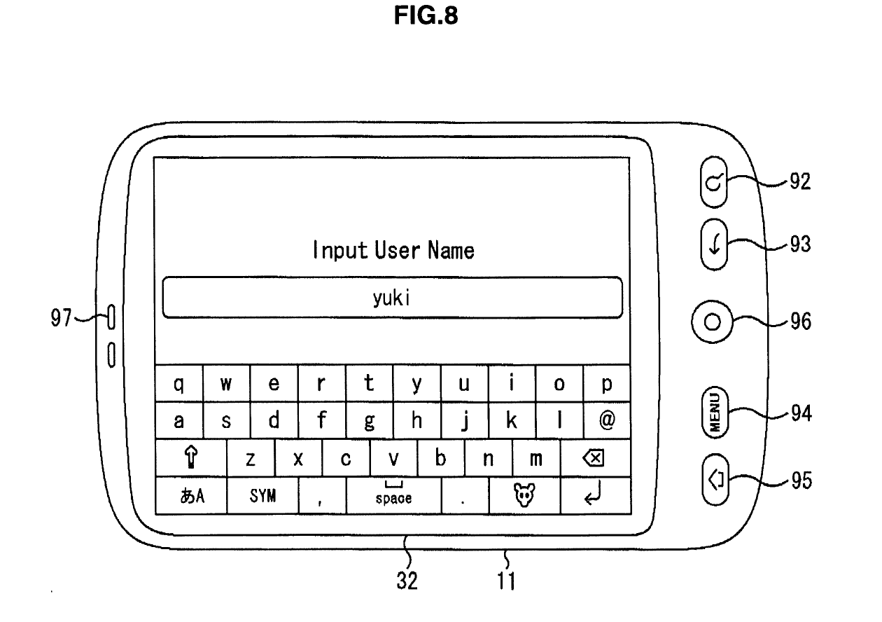

If the user name is not superimposed with the two-dimensional code 82, the display of “‘yuki’ entered” in the right upper position of the start screen 91 is omitted, and a user registration screen 101 illustrated in FIG. 8 is displayed on the display section 32 of the portable terminal 11 as a user registration process of step S13. The user inputs the user name using a software keyboard displayed on the user registration screen 101 illustrated in FIG. 8, and enters the input by pressing the return button 93 which is assigned as an enter button.

Here, if the photograph sharing application 51 has been started in the portable terminal 11 in the past, and the photograph sharing application 51 holds the user name used at that time, that user name may be used as a default name. Even if a user name is superimposed with the two-dimensional code 82 or is already registered, the user registration screen 101 illustrated in FIG. 8 may be arranged to be displayed by settings.

If the user has been already registered, or when the user registration completes, the entirety controller 63 performs a connection process in step S14.

### [Description of Connection Process]

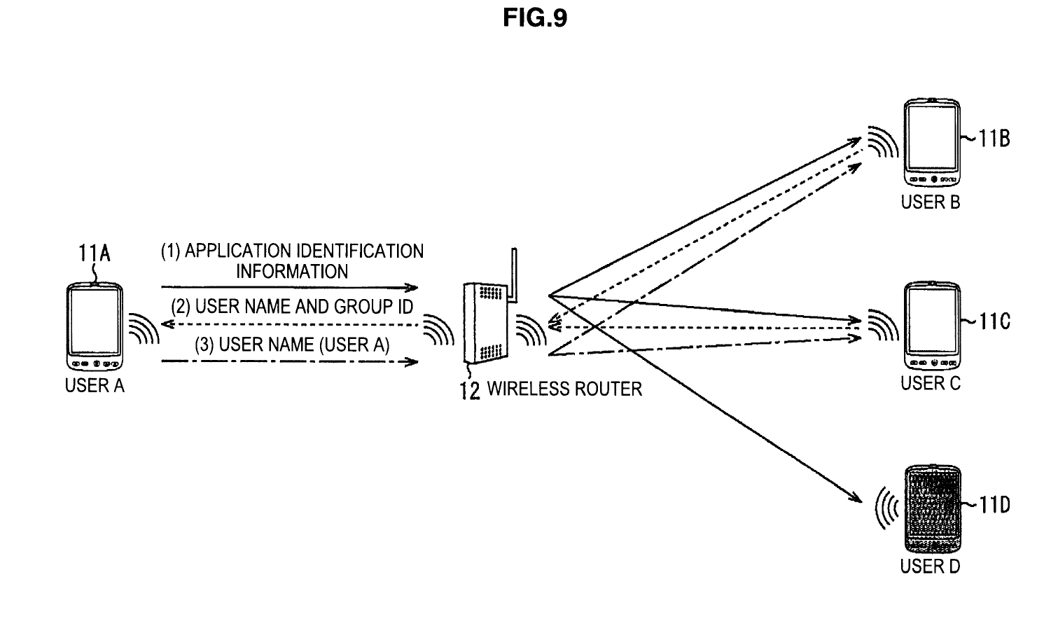

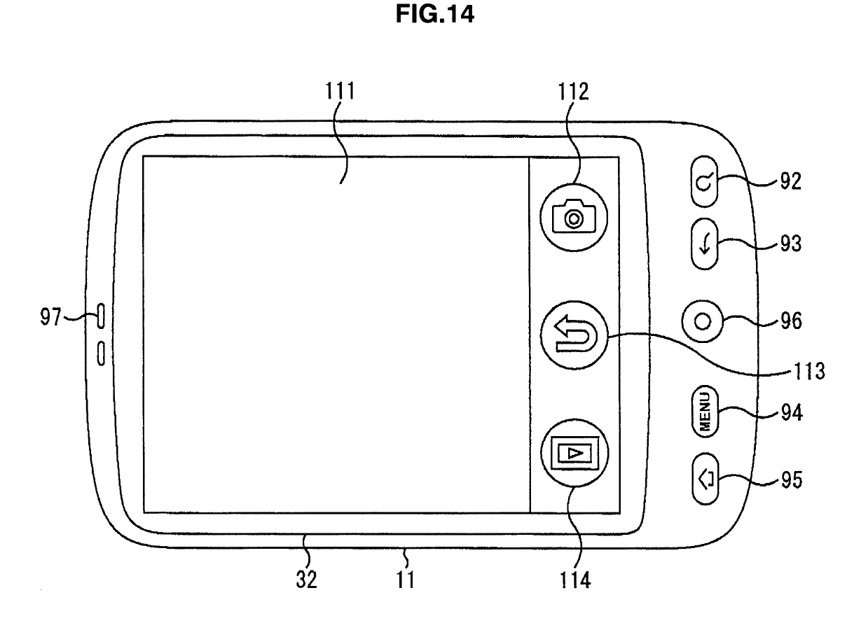

Referring to FIG. 9, the connection process performed in step S14 will be briefly described. The details of the connection process will be described later with reference to FIG. 16.

If it is assumed that the portable terminal 11 that has started the photograph sharing application 51 is the portable terminal 11A of the user A, the portable terminal 11A broadcasts, by UDP communication, application identification information for identifying the photograph sharing application 51.

Upon receiving the application identification information that is broadcast, the other portable terminal 11 which is executing the photograph sharing application 51 returns its own user name and group ID. This response is transmitted by TCP communication.

According to the example in FIG. 9, it is assumed that the photograph sharing application 51 is executed (started) in the portable terminals 11B and 11C, and the photograph sharing application 51 is not executed (started) in the portable terminal 11D. In this case, the portable terminals 11B and 11C return their own user names and group IDs, and the portable terminal 11D does not respond to the received application identification information.

The portable terminal 11A that receives the user name and the group ID from the other portable terminal 11 adds the received user name as a user in the same group to a user list in the terminal if the transmitted group ID coincides with its own group ID. Further, the portable terminal 11A transmits its own user name to the portable terminal 11 of the user of the same group which is added to the user list. According to the example in FIG. 9, the portable terminal 11A transmits its own user name to the portable terminals 11B and 11C. This is transmitted by TCP communication. To state it differently, since the first broadcast is performed by UDP communication by which the reception is not secured, the user name is transmitted by TCP communication to the portable terminal 11 which has responded and is of the user in the same group.

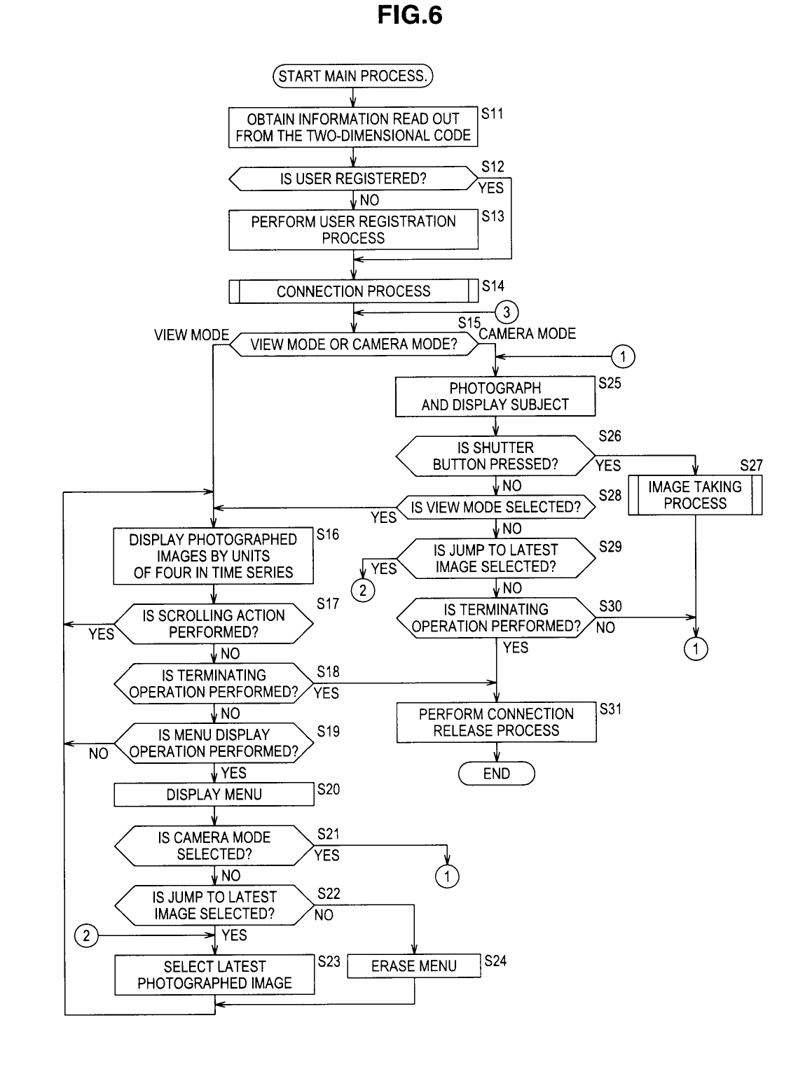

Referring back to FIG. 6, when the connection process in step S14 completes, the entirety controller 63 determines whether the operation mode is the View mode or the Camera mode in step S15. Immediately after the startup, either the View mode or the Camera mode which has been decided in advance is selected.

In step S15, if the operation mode is determined to be the View mode, the process advances to step S16, and the View mode controller 62 displays the photographed images that were photographed in the past and are stored in the storage section 27 on the display section 32 by units of four (units of a predetermined number) in time series.

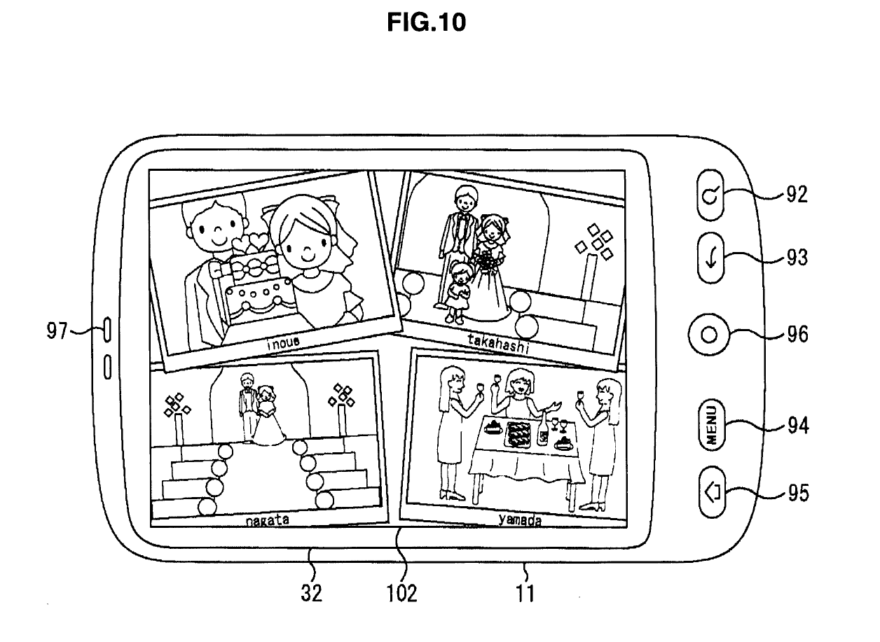

FIG. 10 illustrates an example of a View mode image 102 in which four photographed images to be displayed by the View mode controller 62 on the display section 32 and stored in the storage section 27 are arranged in time series in step S16. The view mode image 102 includes four photographed images, and names of the users (user names in the photograph sharing application 51) who photographed these photographed images are displayed in frames of the individual photographed images. With this arrangement, it is possible to understand, at a glance, who took these photographed images.

Then, when the user touches and performs scrolling action in the right or left direction on a top surface of the display section 32 on which a touch panel is overlapped as illustrated in FIG. 11, four previous or subsequent photographed images in time series with respect to the four photographed images currently displayed are displayed in the display section 32. An arrow in the right or left direction displayed on the display section 32 in FIG. 11 indicates a scrolling direction in FIG. 11 and is not actually displayed on the display section 32. Flick operation may be used instead of the scrolling action.

Accordingly, in step S17 following step S16 illustrated in FIG. 6, the View mode controller 62 determines whether the scrolling action is performed. If it is determined that the scrolling action is performed in step S17, the process returns to step S16. With this arrangement, in step S16 again, four previous or subsequent photographed images in time series according to the scrolling direction are displayed in the display section 32.

In contrast, if it is determined that the scrolling action is not performed in step S17, the process advances to step S18, and the View mode controller 62 determines whether terminating operation to end the photograph sharing application 51 is performed or not. For example, the home button 95 is assigned as an operation button for instructing the end of the process, and the View mode controller 62 determines whether the home button 95 is operated or not.

If it is determined that the terminating operation is performed in step S18, the process advances to step S31 which will be described later.

In contrast, if it is determined that the terminating operation is not performed in step S18, the process advances to step S19, and the View mode controller 62 determines whether menu display operation is performed or not. For example, the menu button 94 is assigned as an operation button for displaying a menu, and the View mode controller 62 determines whether the menu button 94 is operated or not. In addition, by tapping on the display section 32 of the portable terminal 11, a menu button 103 arranged by the software is displayed by the View mode controller 62 as illustrated in FIG. 12, and the View mode controller 62 determines whether the menu button 103 is operated or not.

If it is determined that the menu display operation is not performed in step S19, the process returns to step S16. In contrast, if it is determined that the menu display operation is performed in step S19, the process advances to step S20, and the View mode controller 62 displays the menu.

### [Example of Menu Display]

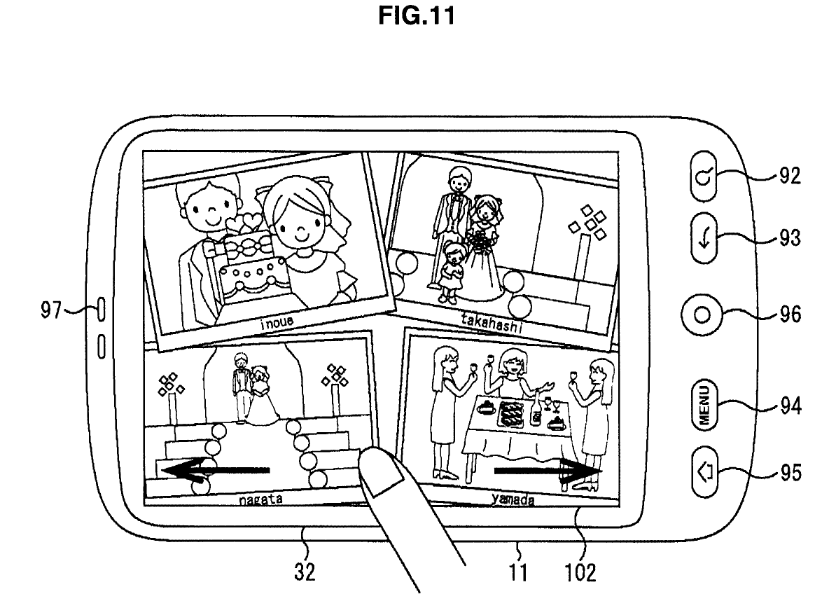

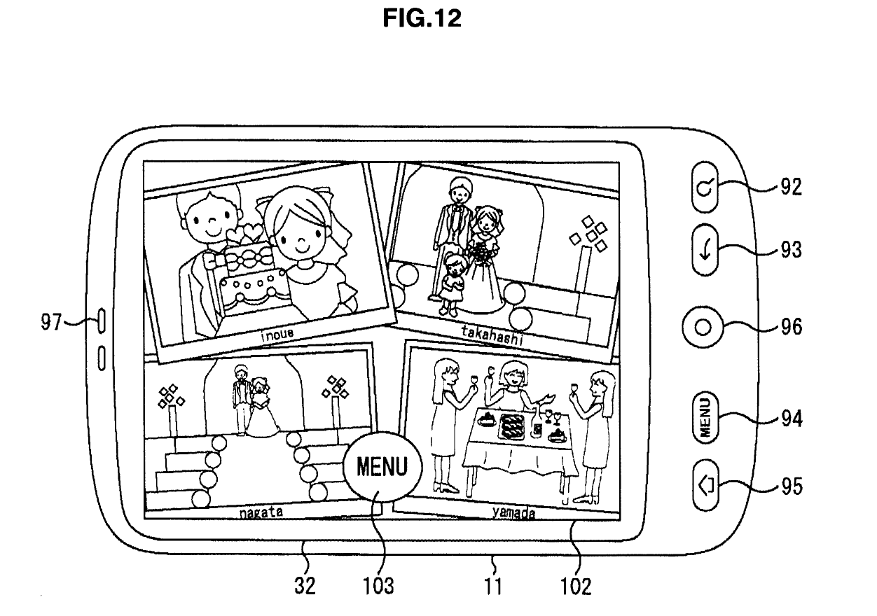

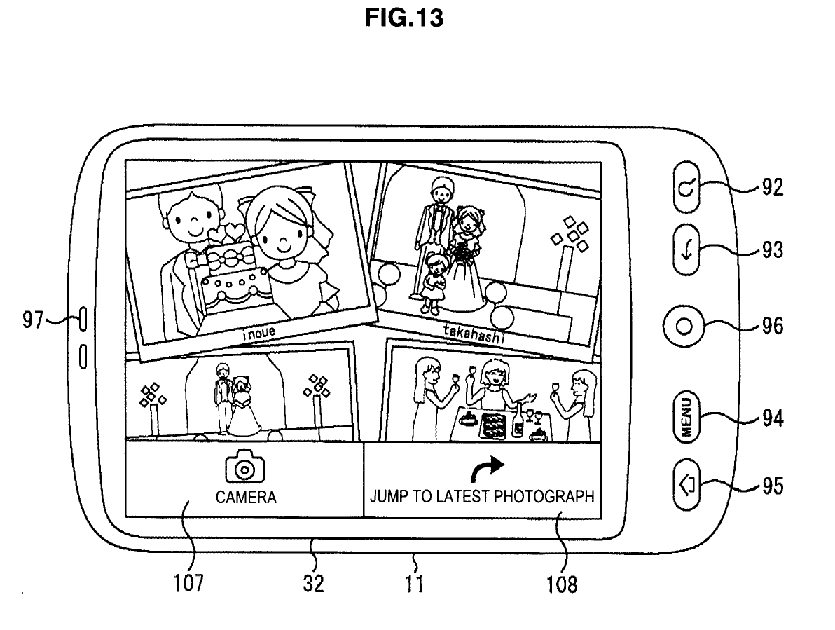

FIG. 13 illustrates an example of the menu displayed by the View mode controller 62 in step S20.

When the menu display operation is performed, the View mode controller 62 displays, on the display section 32, a Camera mode change button 107 for changing the operation mode to the Camera mode and a latest image display button 108 for displaying a latest photographed image.

In step S21, the View mode controller 62 determines whether the Camera mode is selected or not, i.e., whether the Camera mode change button 107 is touched or not. If it is determined that the Camera mode is selected in step S21, the process advances to step S25 which will be described later.

In contrast, if it is determined that the Camera mode is not selected in step S21, the process advances to step S22, and the View mode controller 62 determines whether a jump to the latest image is selected or not, i.e., whether the latest image display button 108 is touched or not.

If it is determined that the jump to the latest image is selected in step S22, the process advances to step S23, and the View mode controller 62 selects four latest photographed images in terms of photographed time from among the photographed images stored in the storage section 27 and brings the process back to step S16.

In contrast, if it is determined that the jump to the latest image is not selected in step S22, the process advances to step S24, and the View mode controller 62 erases the displayed menu and brings the process back to step S16.

Further, if it is determined that the operation mode is the Camera mode in the above-mentioned step S15, the process advances to step S25. In step S25, the Camera mode controller 61 photographs a subject and displays the subject on the display section 32. This means that the Camera mode controller 61 displays an image of the subject taken by the image capturing section 35 on the display section 32.

### [Example of Camera Mode Screen]

FIG. 14 illustrates a screen (image) example which is displayed on the display section 32 in step S25.

A view finder 111 for displaying an image of a subject taken by the image capturing section 35, a shutter button 112, a View mode change button 113 for changing the mode to the View mode, and a latest image display button 114 for displaying a latest photographed image are displayed on the display section 32 in the Camera mode.

Then, in step S26 illustrated in FIG. 6, the Camera mode controller 61 determines whether the shutter button 112 is operated or not.

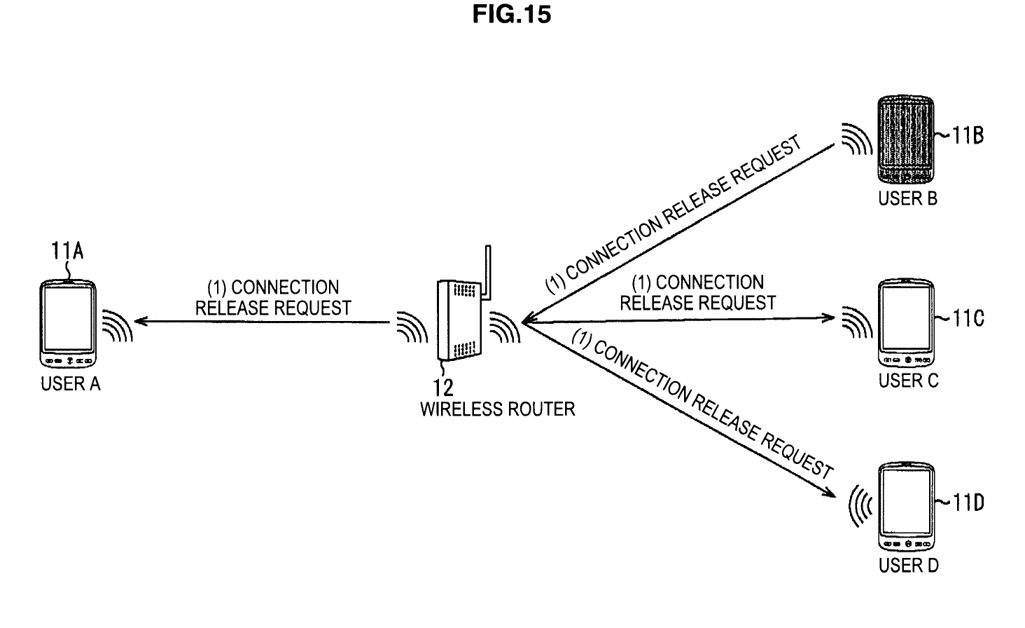

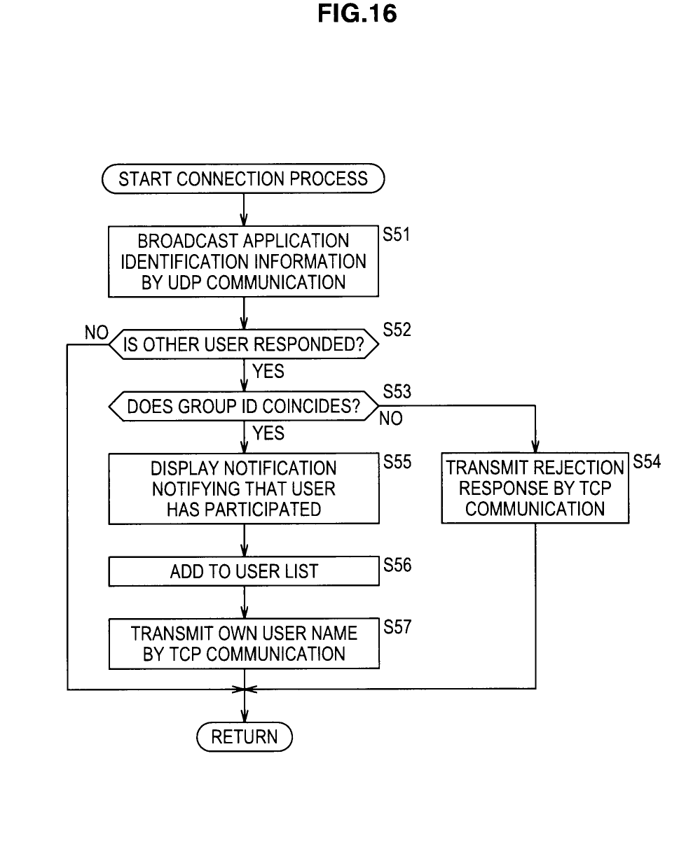

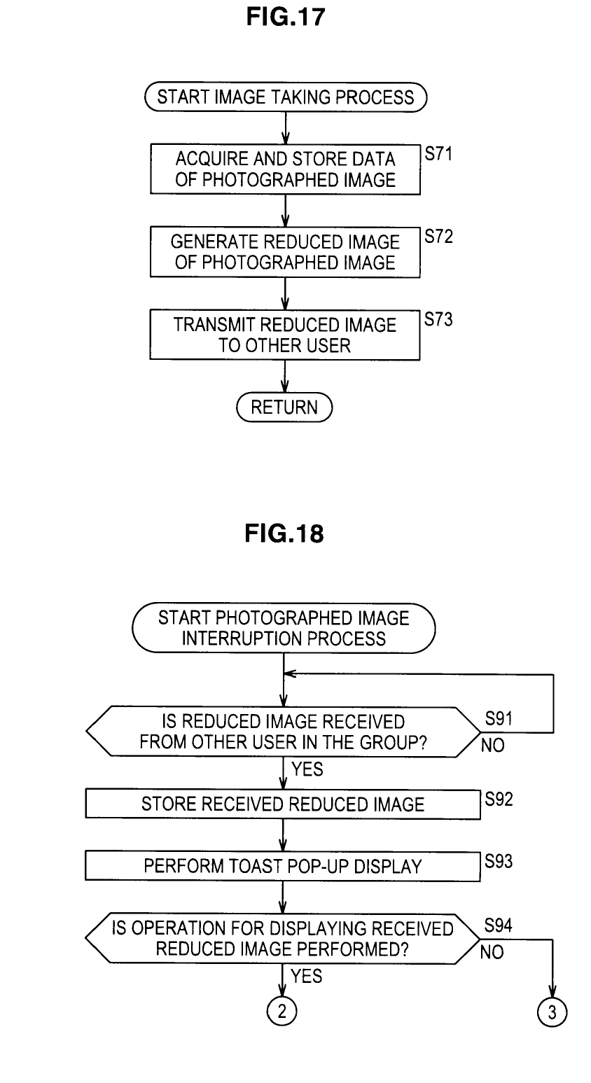

If it is determined that the shutter button 112 is operated in step S26, the process advances to step S27, and the Camera mode controller 61 performs an image taking process which will be described later by referring to FIG. 17. Thereafter, the process returns to step S25.

In contrast, if it is determined that the shutter button 112 is not operated in step S26, the process advances to step S28, and the Camera mode controller 61 determines whether the View mode is selected, i.e., whether the View mode change button 113 is operated.

If it is determined that the View mode is selected in step S28, the process advances to the above-mentioned step S16.

If it is determined that the View mode is not selected in step S28, the process advances to step S29, and the Camera mode controller 61 determines whether the jump to the latest image is selected, i.e., whether the latest image display button 114 is pressed.

If it is determined that the jump to the latest image is selected in step S29, the process advances to step S23.

In contrast, if it is determined that the jump to the latest image is not selected in step S29, the process advances to step S30, and the Camera mode controller 61 determines whether terminating operation is performed.

If it is determined that the terminating operation is not performed in step S30, the process returns to step S25. With this arrangement, a state in which the subject is photographed and displayed on the display section 32 continues.

In contrast, if it is determined that the terminating operation is performed in step S30, i.e., if the home button 95 is operated, the process advances to step S31, and the entirety controller 63 performs a connection release process and ends the main process.

### [Description of Connection Release Process]

Referring to FIG. 15, the connection release process performed in step S31 will be described. In the example illustrated in FIG. 15, it is assumed that the portable terminal 11 which performs the terminating operation of the photograph sharing application 51 is the portable terminal 11B of the user B.

The portable terminal 11B transmits a connection release request by TCP communication to all users registered in the user list and connected at present. The connection release request is a message for requesting a deletion from the user list so that the requesting user (user B) leaves from a group (network) identified by the group ID thereof.

The portable terminal 11A or the like that receives the connection release request deletes the user B of the portable terminal 11B from the user list. The portable terminal 11A or the like that receives the connection release request does not return a response message in particular.

As described above, when the photograph sharing application 51 is terminated, the termination of the photograph sharing application 51 is notified to the other portable terminals 11 in the same group, and the recipient can delete the requesting user from the user list in the portable terminal 11 on the recipient side.

### [Detailed Flow of Connection Process]

Next, referring to the flowchart in FIG. 16, details of the connection process performed in step S14 in FIG. 6 will be described.

First, in step S51, the entirety controller 63 broadcasts by UDP communication the application identification information for identifying the photograph sharing application 51.

Then, in step S52, the entirety controller 63 determines whether other users (portable terminals 11 of the other users) return the response. If it is determined that the other users do not respond, the process returns to the process illustrated in FIG. 6.

In contrast, if it is determined, in step S52, that the other user responds, i.e., if the entirety controller 63 receives the user name and the group ID from the other portable terminal 11, the entirety controller 63 determines, in step S53, whether the received group ID coincides with its own group ID.

If it is determined that the received group ID does not coincide with its own group ID in step S53, the process advances to step S54, and the entirety controller 63 transmits a rejection response to the portable terminal 11 by TCP communication.

In contrast, if it is determined that the received group ID coincides with its own group ID in step S53, the process advances to step S55, and the entirety controller 63 displays a notification to notify that a user has participated. Specifically, the entirety controller 63 allows a massage of “‘****’ entered” as displayed in the right upper position of the start screen 91 in FIG. 7 to be displayed. Here, the portion of ‘****’ shows a user name whose group ID coincides with its own group ID. If a user leaves the group by performing the connection release for the user of the same group which was described with reference to FIG. 15, the entirety controller 63 displays “‘****’ left” in the right upper position of the screen.

In step S56, the entirety controller 63 adds the user name of the user whose group ID coincides with its own group ID to the user list by associating the user name with an IP address which is identification information of the portable terminal 11 on the network.

Further, in step S57, the entirety controller 63 transmits its own user name by TCP communication to the user whose group ID coincides with its own group ID and ends the connection process, and then the process returns to the process illustrated in FIG. 6. The processes in steps S55 to S57 can be performed in parallel.

The portable terminal 11 that receives the user name transmitted as a result of the process in step S57 also performs a process of adding the received user name to its own user list by associating the user name with the IP address in a similar manner.

As described above, the entirety controller 63 forms the same group with other portable terminal 11 whose group ID coincides with its own group ID and thereby forms a group with one or more other portable terminals 11 on the local area network.

### [Detailed Flow of Image Taking Process]

Next, referring to the flowchart in FIG. 17, the image taking process performed in step S27 in FIG. 6 will be described.

In the image taking process, first, in step S71, the Camera mode controller 61 acquires data of the photographed image obtained by the image capturing section 35 and stores it in the storage section 27.

In step S72, the Camera mode controller 61 creates a reduced image by reducing the photographed image obtained in step S71 at a predetermined ratio such as 1/2.

In step S73, the Camera mode controller 61 transmits, by TCP communication, the reduced image that is created in step S72 to the other users who are in the same group and registered in the user list, and the process returns to the process illustrated in FIG. 6.

### [Flow of Photographed Image Interruption Process]

FIG. 18 is a flowchart of a photographed image interruption process of the portable terminal 11 which is a process for receiving the reduced image transmitted from the other portable terminal 11 as a result of the image taking process illustrated in FIG. 17. This process is performed separately, at regular intervals, in parallel with the main process illustrated in FIG. 6.

First, in step S91, the entirety controller 63 determines whether it receives the reduced image from the other user (portable terminal 11 of the other user) in the group, and is on standby until it is determined that the reduced image is received.

If it is determined that the reduced image is received from other user in the group in step S91, the process advances to step S92, and the entirety controller 63 stores the reduced image received from the other user in the storage section 27. Data of the received reduced images are stored in the storage section 27 in association with the user names from which the reduced images are transmitted.

Then in step S93, the entirety controller 63 performs a toast pop-up display indicating that a reduced image is received from the other user.

### [Example of Toast Pop-Up Display]

FIG. 19 illustrates an example of a toast pop-up display when a reduced image is received from the other user. Although FIG. 19 illustrates an example when the operation mode is in the View mode, the same is also applied to the Camera mode.

In the View mode, the display section 32 displays the View mode image 102 in which four photographed images are arranged in time series. In this state, upon receiving a reduced image from the other user, the entirety controller 63 allows a new arrival notification 121 with a display of a thumbnail of the received reduced image to be displayed in a toast pop-up together with a message of “A photograph has arrived.” Specifically, on the display section 32, the new arrival notification 121 is faded in for one second, displayed for three seconds, and faded out in one second on the View mode image 102.

When the user selects by tapping on the new arrival notification 121 displayed in the View mode image 102, the entirety controller 63 displays four photographed images having the latest photographed time including the received reduced image.

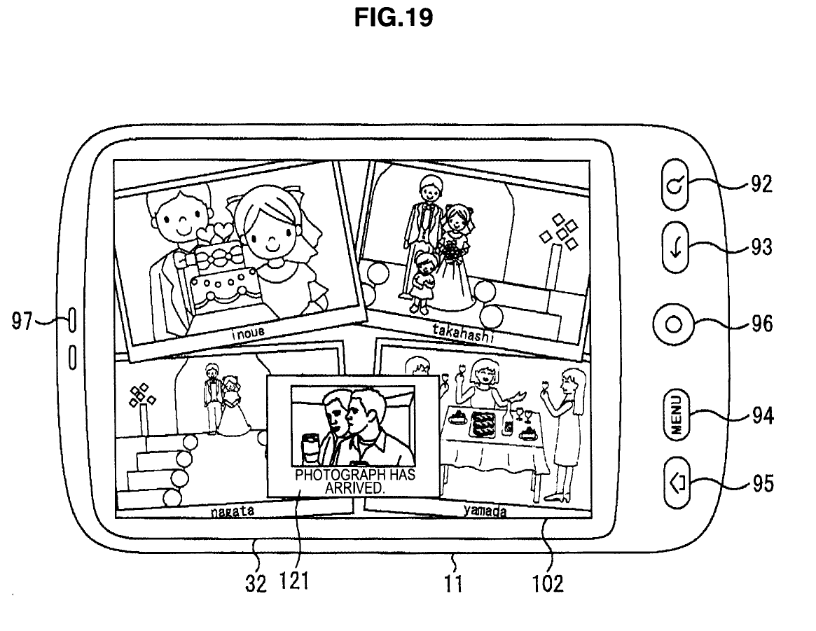

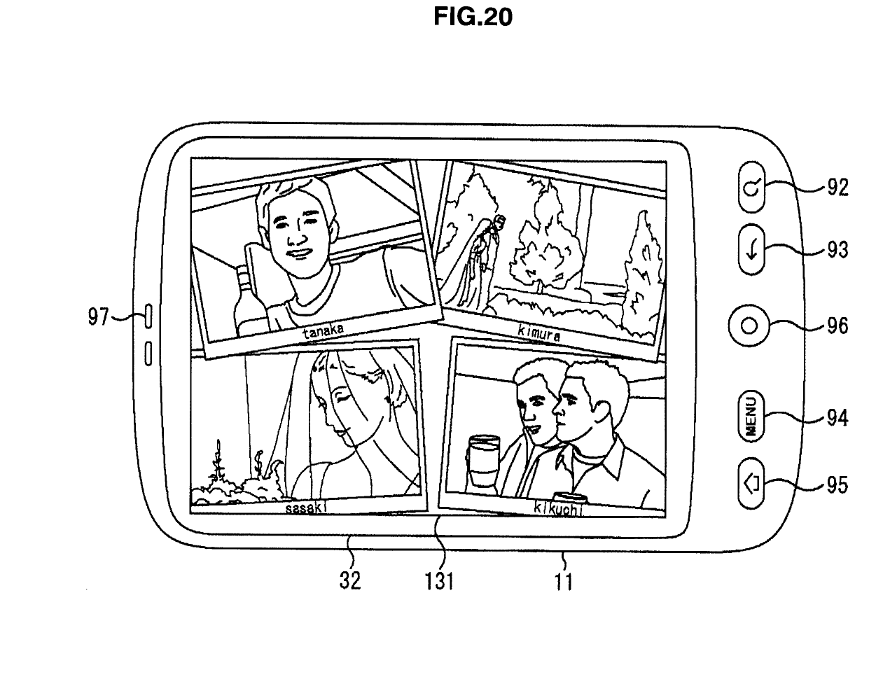

FIG. 20 illustrates an example of the View mode image 131 displayed on the display section 32 when the user selects the new arrival notification 121 by tapping thereon.

The photographed image arranged in the right bottom position among the four photographed images that form the View mode image 131 illustrated in FIG. 20 is the one that has been received latest and corresponds to the thumbnail which is displayed in a toast pop-up manner in FIG. 19. The displayed size of each photographed image that forms the View mode image 131 coincides with a size of the reduced image received from the other user.

Referring back to FIG. 18, after the toast pop-up image of the received reduced image is performed in step S93, the entirety controller 63 determines, in step S94, whether operation for displaying the received reduced image is performed or not. To state it differently, the entirety controller 63 determines whether operation for tapping on the new arrival notification 121 is performed.

If it is determined that the operation for displaying the received reduced image is performed in step S94, the process advances to step S23 of the main process in FIG. 6 and merges with the main process. As a result, as described above, the latest photographed images (reduced images) including the reduced image which have been received most recently are displayed on the display section 32.

In contrast, if it is determined that the operation for displaying the received reduced image is not performed in step S94, the process advances to step S15 of the main process in FIG. 6 and merges with the main process. As a result, the toast pop-up display ends, and the process that has been performed so far continues.

As described above, the portable terminal 11 transmits the reduced image resulted from reducing the photographed image that is taken by the image capturing section 35 to the other portable terminals 11 in the same group and receives the reduced images of the photographed images that are taken by the other portable terminals 11 in the same group. Then, the portable terminal 11 that has received the reduced image performs a toast pop-up display indicating the reception thereof and displays, on the display section 32, a predetermined number (four) of the latest reduced images (photographed images) including the received reduced image when displaying the received reduce image is instructed.

As a result of this, the plurality of users belonging to the same group can quickly view, on site, the photographed images taken by the other users. Further, since the reduced image resulted from reducing the photographed is transmitted, the data amount becomes smaller than that in the case where the photographed image is transmitted as is, and the times used for transmission and reception become shorter, which makes it possible to quickly view the photographed images taken by the other users.

### [Description of User List Consistency Maintenance Process]

Next, a user list consistency maintenance process performed by the photograph sharing application 51 will be described.

For example, when a user belonging to a predetermined group leaves a communication range of the wireless router 12 such as visiting the bathroom, it may be possible that the transmission to that user results in a transmission error (reception of the transmission becomes incomplete). Because, a connection release process has not been performed, and therefore that user remains registered in the user list, which allows a message (data) to be transmitted to that user. The user list consistency maintenance process is a process to solve such a transmission error.

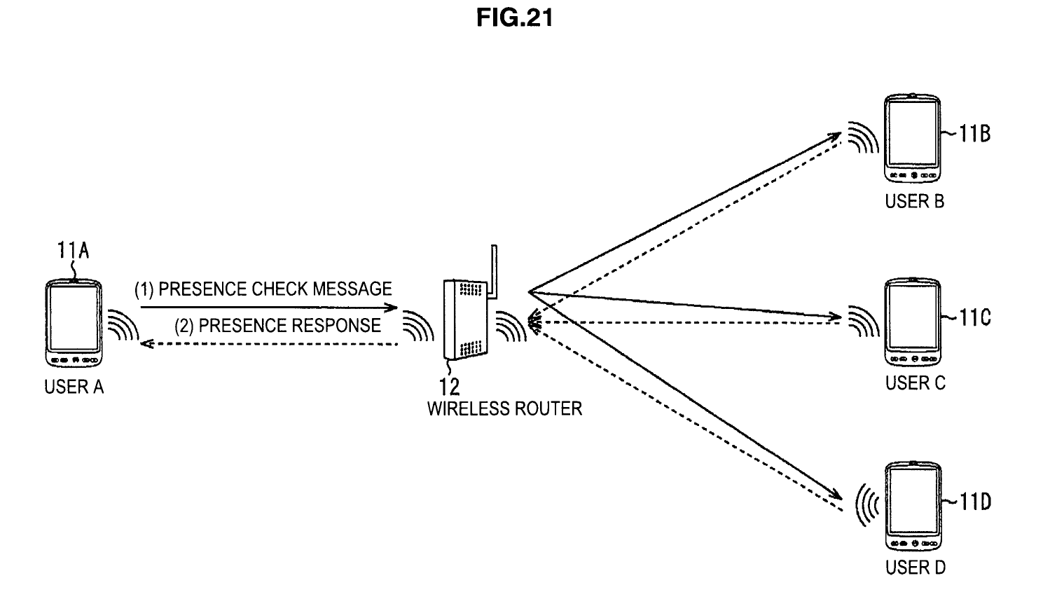

As illustrated in FIG. 21, in the user list consistency maintenance process, the portable terminal 11 executing the photograph sharing application 51 periodically transmits a presence check message to each user registered in its user list.

The other portable terminal 11 that has received the presence check message returns a response (presence response) indicating the presence thereof. The portable terminal 11 that transmitted the presence check message updates its user list according to whether it has received the presence response or not from the other user.

This kind of process is performed by each portable terminal 11 that executes the photograph sharing application 51 and thereby maintains the consistency of its own user list.

### [Flow of User List Consistency Maintenance Process]

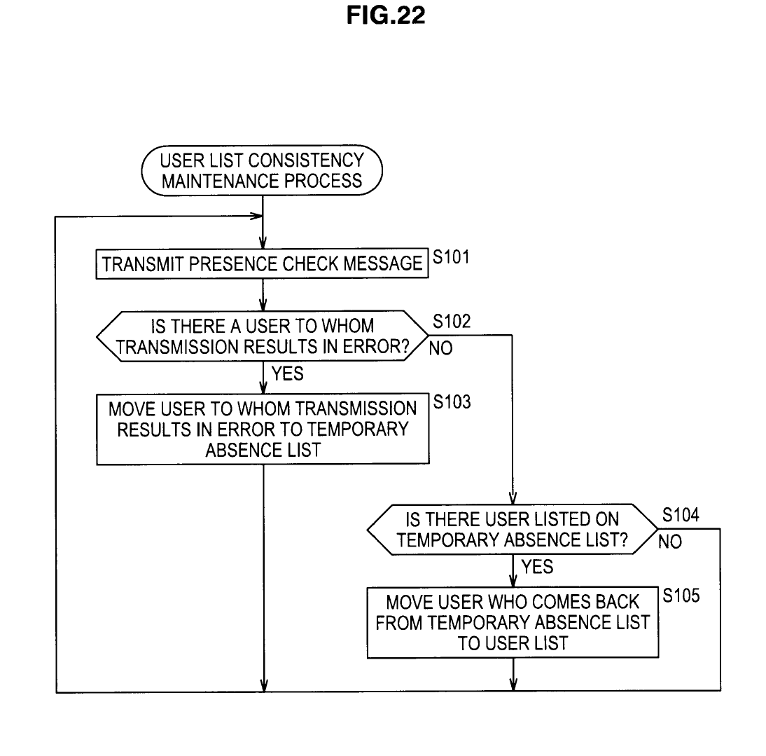

FIG. 22 illustrates a flowchart of the user list consistency maintenance process. This process is performed separately, at regular intervals, in parallel with the main process illustrated in FIG. 6 or the photographed image interruption process illustrated in FIG. 18.

First, in step S101, the user management section 71 of the entirety controller 63 transmits the presence check message to each user registered in its own list.

In step S102, the user management section 71 determines whether there is a user to whom the transmission results in a transmission error.

If it is determined that there is a user to whom the transmission results in a transmission error in step S102, the process advances to step S103, and the user management section 71 moves the user relating to the transmission error from the user list to a temporary absence list. The temporary absence list is a list that stores thereon a user name and an IP address of a user for whom the connection release process was not performed and to whom the transmission resulted in a transmission error. After step S103, the process returns to step S101.

In contrast, if it is determined that there is no user to whom the transmission resulted in a transmission error in step S102, the process advances to step S104, and the user management section 71 determines whether a user on the temporary absence list coincides with a user among the users to whom the transmissions were preformed.

If it is determined that such a user is found in the temporary absence list in step S104, i.e., if there is a user to whom the transmission error is not repeated, the process advances to step S105, and the user management section 71 moves the user to whom the transmission error is not repeated from the temporary absence list to the user list.

If it is determined that such a user is not found in the temporary absence list after step S105 or in step S104, the process returns to step S101. Thereafter, the process from step S101 to step S105 is repeated.

According to this user list consistency maintenance process, the user to whom the presence check message is transmitted, which results in a transmission error, is only moved to the temporary absence list but is not deleted. For the user on the temporary absence list, the transmission of the photographed image obtained by photographing can be temporarily suspended and can be repeated after such a user comes back. With this arrangement, the user can be appropriately managed even the user leaves the communication range of the wireless router 12.

### [Example of Another Display Method of Photographed Image]

An example of another display method of the photographed image (reduced image) will be described.

According to the foregoing embodiment, as described with reference to FIG. 11, when the user performs scrolling action (or flick operation) in the right or left direction on the top surface of the display section 32, previous or subsequent photographed images in time series with respect to the currently displayed photographed images are displayed.

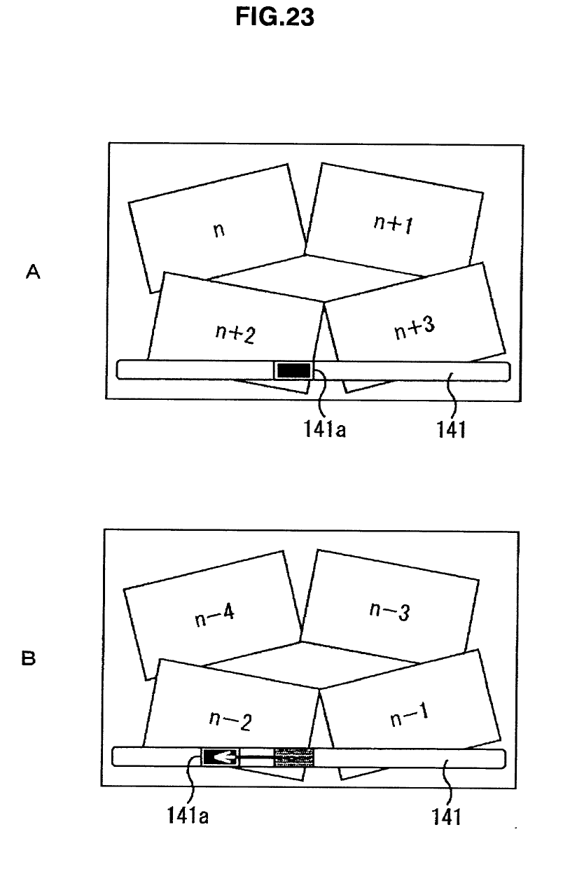

However, for example, it is also possible to superimpose a slide bar 141 on the View mode image in which four photographed images are displayed as illustrated in FIG. 23A, and display four photographed images that were taken at a photographed time corresponding to a position of a slider 141a of the slide bar 141 moved by the user.

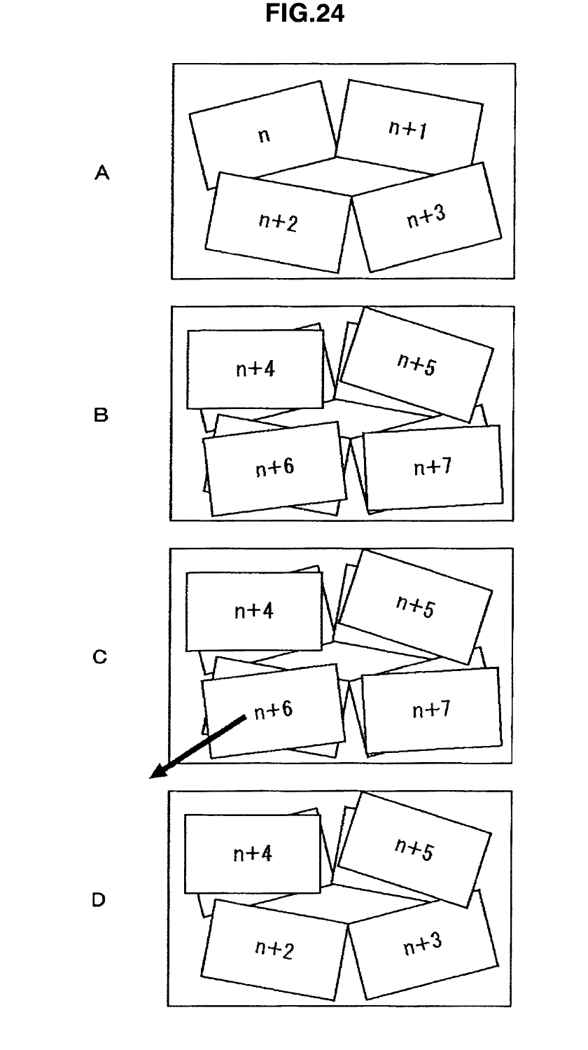

In an example illustrated in FIG. 23B, the slider 141a is moved to a predetermined position toward the left from the position illustrated in FIG. 23A, and four photographed images in FIG. 23B are the images of the past in time series relative to the four photographed images illustrated in FIG. 23A. In FIG. 23, the photographed images indicate, thereon, n−4, n−3, n−2, n−1, n, n+1, n+2, n+3, and n+4. These numerals indicate that as the value thereof is larger with respect to n (where n>4), the photographed time of the photographed image indicating the numeral is later. This also applies to FIGS. 24A to 24D which will be described below.

FIGS. 24A to 24D illustrate an example of another display method of the photographed image, and illustrates an example in which four photographed images in time series are overlapped in a random manner with one another and displayed.

In FIG. 24A, four photographed images indicating n, n+1, n+2, and n+3 are displayed. In FIG. 24B, on the four photographed images illustrated in FIG. 24A, photographed images indicating n+4, n+5, n+6, and n+7 which are photographed subsequent thereto are displayed.

In FIG. 24B, since the four photographed images having later photographed time are overlaid in a random manner on the group of four photographed images previously described with reference to FIG. 24A, the user can view only fractions of the photographed images having older photographed times and laid underneath. However, photographed images that can be entirely viewed by the user are only the four photographed images that are laid on top.

It is assumed that the user, for example, touches the photographed image indicating n+6 and performs flick operation in a direction indicated by an arrow (toward outside of the screen) in FIG. 24C while the four photographed images indicating n+4, n+5, n+6, and n+7 illustrated in FIG. 24B are displayed. In this case, the View mode controller 62 performs a display control process for erasing the photographed image indicating n+6 and the photographed images having later photographed times. According to the example illustrated in FIG. 24C, the photographed images indicating n+6 and n+7 are erased, and four photographed images indicating n+5, n+4, n+3, and n+2 having photographed times previous to that of n+6 starting from the photographed image indicating n+5 are displayed as illustrated in FIG. 24D.

In this way, the View mode controller 62 displays the photographed images in an overlapping manner by units of four in an up-and-down direction (vertical direction with respect to the screen) in a time series, and, when operation is performed to remove one of the photographed images displayed on top, the View mode controller 62 performs display control of erasing the photographed image on which the operation for removing is performed and the photographed images having the chorological order (later time in FIG. 24B) corresponding to the upward direction therefrom among the four photographed imaged displayed on top. Although the photographed images are laid vertically so that the upper image have a later photographed time in the example illustrated in FIG. 24, the relationship between the chorological order and the vertical direction may be reversed.

According to this display control, when the user performs operation in an image of pushing aside the photographed images laid vertically, the user can easily view the photographed images in a time series.

Although the foregoing is an example of displaying the photographed images by units of four, the number of photographed images to be displayed simultaneously is not limited to this example and may be set to a predetermined number.

### Modifications

According to the embodiment described above, the portable terminal 11 is exemplified by a highly-functional portable telephone called a smartphone in which a portable telephone and a portable information terminal are combined together. However, the portable terminal 11 may be other devices, for example, a tablet terminal, a PDA (Personal Digital Assistant), a handheld game device, or the like as long as the device has a network connecting function. Further, other than the portable terminal 11, the device may be an electronic apparatus having a network connecting function such as an image display device including a portable television set, a laptop (portable type) computer, a television set, a projector, or the like. To state it differently, the portable terminal 11 is merely an example of an electronic apparatus that forms a network of the communication system 1 illustrated in FIG. 1, and therefore such an electronic apparatus as a tablet terminal or a handheld game device may be connected to the network of the communication system 1 and perform the photograph sharing application 51.

For example, when an image display device having a large screen which is installed in an event site is added as a device for forming the communication system 1, the photographed image obtained by photographing by the portable terminal 11 of a predetermined user can be displayed on the image display device having a large screen in addition to displaying the same on the portable terminal 11 of other users. It is often the case that touch operation (scrolling action or flick operation) as performed on the display section 32 of the portable terminal 11 may not be performed in such an image display device having a large screen. In that case, the operation can be performed by operating on arrow keys of a remote controller attached to the image display device.

Further, the communication on the network among individual electronic apparatuses that form the communication system 1 also may include those that are performed by a wire communication in addition to the wireless communication.

It should be noted that, in this specification, in addition to the steps described in the flowcharts which are performed sequentially as described in time series, the steps may be performed in parallel, at a timing when the step is called or the like even if the steps are not necessarily performed in time series.

It also should be noted that, in this specification, the system refers to the whole of the apparatus configured of a plurality of devices.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2011-095017 filed in the Japan Patent Office on Apr. 21, 2011, the entire content of which is hereby incorporated by reference.

What is claimed is:

1. An electronic apparatus comprising:
a group formation section that constitutes a same group with one or more communication terminals on a local area network;
a communication section that receives data of a photographed image that is photographed by the communication terminal belonging to the same group; and
a display section that displays the photographed image thus received.

2. The electronic apparatus according to claim 1, further comprising:
an image capturing section that photographs an image of a subject, wherein the display section displays the photographed image photographed by the image capturing section, and the communication section further transmits data of the photographed image photographed by the image capturing section.

3. The electronic apparatus according to claim 2,
wherein the communication section transmits data of a reduced image resulted from reducing the photographed image photographed by the image capturing section at a predetermined ratio to the communication terminal belonging to the same group, and receives data of a reduced image resulted from reducing a photographed image photographed by the communication terminal at the predetermined ratio.

4. The electronic apparatus according to claim 1,
wherein the communication section receives group identification information for identifying the group from the communication terminal, and the group formation section forms the same group with the communication terminal having the group identification information that coincides with group identification information of the electronic apparatus.

5. The electronic apparatus according to claim 4, further comprising:
a group identification information obtaining section that obtains the group identification information.

6. The electronic apparatus according to claim 5,
wherein the group identification obtaining section obtains the group identification information that is read out from a two-dimensional code or a URL.

7. The electronic apparatus according to claim 1,
wherein the display section displays the photographed image in time series by units of a predetermined number.

8. The electronic apparatus according to claim 7,
wherein the display section displays the photographed images by units of the predetermined number so that the photographed images are overlaid on top of another by associating a time series thereof with a vertical direction, and when operation to erase the photographed image displayed on top is performed, the photographed image on which the operation to erase is performed and the photographed images arranged in a time series corresponding thereto and above are erased.

9. The electronic apparatus according to claim 7,
wherein, when the communication terminal receives data of the photographed image photographed by the communication terminal, the display section performs a display indicating a receipt thereof, and when displaying the photographed image thus received is instructed, the display section displays the predetermined number of the photographed images that are the latest including the photographed image thus received.

10. A control method for an electronic apparatus including a group formation section, a communication section, and a display section, the method comprising:
forming by the group formation section a same group with one or more communication terminals on a local area network;
receiving by the communication section data of a photographed image that is photographed by the communication terminal belonging to the same group; and
displaying by the display section the photographed image thus received.

11. A program causing computer to execute:
forming a same group with one or more communication terminals on a local area network;
receiving data of a photographed image that is photographed by the communication terminal belonging to the same group; and
displaying the photographed image thus received on a display section.
